(19) United States
(12) Patent Application Publication
(10) Pub. No.: US 2003/0043429 A1
(43) Pub. Date: Mar. 6, 2003

(54) High capacity backbone

(76) Inventors: Ken Dumble, Belmont, MA (US); Matthew Miller, Mansfield, MA (US); Edward J. Kearns, Hollis, NH (US); Helen Butcher, Woburn, MA (US); John Booth, Norcross, GA (US); Vincent Fuller, Palo Alto, CA (US)

Correspondence Address: FISH & RICHARDSON PC, 225 FRANKLIN ST, BOSTON, MA, 02110, US

(21) Appl. No.: 09/941,170

(22) Filed: Aug. 28, 2001

(51) Int. Cl. H04J 14/00

(52) U.S. Cl. 359/124; 359/123

(57) ABSTRACT

A communication system includes an optical transmission network having an input end and an output end. A wavelength division multiplexer coupled to the input end of the optical transmission network receives data packets directly from each internet-traffic source and modulates, in response to those data packets, a corresponding optical beam having a selected wavelength. At the other end of the optical transmission network, a wavelength division demultiplexer is configured to select a particular optical beam corresponding to each internet-traffic source and to retrieve the data packets placed thereon by the wavelength division multiplexer.

### TECHNICAL FIELD

This invention relates to communication systems.

### BACKGROUND

In a long-distance carrier's backbone network, the network nodes are telephone sets that typically have only the most rudimentary processing capabilities. As a result, error correction or data protection in the telephone network, if it is to exist at all, is provided by the network, and not by telephone sets.

In a telephone network that includes optical fibers, commercially available SONET (“Synchronized Optical Network”) infrastructure bears the brunt of error detection and correction for data on a working fiber. This enables the telephone sets to remain free of processing equipment. In such networks, a diversely routed protection fiber provides the basis for data protection should the working fiber of the SONET network be severed.

In recent years, internet traffic has begun sharing the telephone network with non-internet traffic such as that resulting from telephone calls, ATM cells, frame relay, and private line services. To achieve network transparency, internet traffic is treated like conventional telephone traffic. Consequently, routers and other internet-traffic sources that connect to optical fibers typically do so through SONET interfaces. These interfaces embed the TCP/IP packets (hereafter referred to as “data packets”) sent by internet-traffic sources into SONET frames, thereby allowing those data packets to be processed in the same manner as conventional telephone traffic.

Because data packets are placed in SONET frames, each internet-traffic source and destination (referred to collectively as “internet nodes”) in the network must have access to a SONET interface. These SONET interfaces and the infrastructure that supports them add considerable cost and operational complexity to a network.

The overhead associated with SONET networks is justifiable in the case of telephone traffic because no error protection would otherwise exist. However, in the case of internet traffic, there is no longer a basis for justifying this overhead. In comparison to telephone sets, internet-traffic sources and destinations have considerable processing capability. Headers in TCP/IP data packets already carry information that enables routers to perform error correction. Further, TCP/IP protocols are, by design, highly resilient to adverse network conditions. As a result, internet nodes need not depend on a SONET network for protection against disruptions in the network. Consequently, there is little, if any, additional benefit to justify the added cost associated with providing dedicated protection fibers.

### SUMMARY

A communication system according to the invention eliminates the SONET infrastructure between the internet-traffic sources and destinations and the optical fiber. This enables internet traffic to be carried directly on the fiber in its native form, without intermediate SONET multiplexing equipment. By eliminating the need for such equipment, a communication system incorporating the invention eliminates the overhead associated with providing all internet-traffic sources and destinations with access to SONET interfaces. In addition, the communication system also liberates bandwidth that would otherwise be consumed by the SONET network. When internet traffic is carried on the fiber in its native form, the protection fiber need not wait for a disruption in the working fiber before it can be of use. Instead, the protection fiber can immediately be used to carry additional data packets, thereby effectively doubling the bandwidth of the network. Any data protection associated with the internet traffic is provided by the protocol itself, and not by the maintenance of a protection fiber in addition to a working fiber.

The communication system includes an optical transmission network having an input end and an output end. The optical transmission network can be of any type. However, because of anticipated growth in internet traffic, one embodiment of the invention includes an OC-192 capable optical transmission network.

A wavelength division multiplexer coupled to the input end of the optical transmission network receives data packets directly from each internet-traffic source and modulates, in response to those data packets, a corresponding optical beam having a selected wavelength. At the other end of the optical transmission network, a wavelength division demultiplexer is configured to select a particular optical beam corresponding to each internet-traffic source and to retrieve the data packets placed thereon by the wavelength division multiplexer.

In one aspect of the invention, the wavelength division multiplexer includes a plurality of wavelength translators, each being directly connected to an internet-traffic source. The wavelength translators are configured to generate a beam having a selected wavelength and to modulate that beam in response to data packets received from the internet-traffic source. The wavelength translators are all coupled to an optical coupler that combines the beams generated by each wavelength translator and places the superposition of those beams onto the optical transmission network.

In another aspect of the invention, a plurality of wavelength translators is coupled to the output end of the optical transmission network. Each of the wavelength translators is connected to an internet-traffic destination. These wavelength translators are configured to receive data packets from the demultiplexer and to provide those data packets to the internet-traffic destination.

An alternative embodiment of the communication system shares available bandwidth with SONET traffic. In this embodiment, the communication system includes a first SONET interface coupled to the input end of the optical transmission network. This first SONET interface is configured to receive data from a SONET-traffic source for transmission on the optical transmission network. These SONET frames are transmitted on a selected wavelength dedicated to SONET traffic. As a result, their presence does not impact internet traffic carried as data packets on other wavelengths.

The alternative embodiment can also include a second SONET interface coupled to the output end of the optical transmission network. The second SONET interface is configured to retrieve the SONET frame from the optical transmission network and to provide the data contained therein to a SONET-traffic destination.

A communication system according to the invention thus enables internet traffic from many sources to be carried directly on an optical transmission network. This reduces cost by eliminating expensive SONET interfaces at each internet-traffic source and at each internet-traffic destination. The communication system can nevertheless continue to accommodate SONET traffic by placing the SONET traffic onto wavelengths dedicated to such traffic.

Unless otherwise defined, all technical and scientific terms used herein have the same meaning as commonly understood by one of ordinary skill in the art to which this invention belongs.

These and other features of the invention will be apparent from the following detailed description, and the accompanying figures in which:

### DESCRIPTION OF DRAWINGS

FIGS. 1 and 2 are communication systems according to the invention.

### DETAILED DESCRIPTION

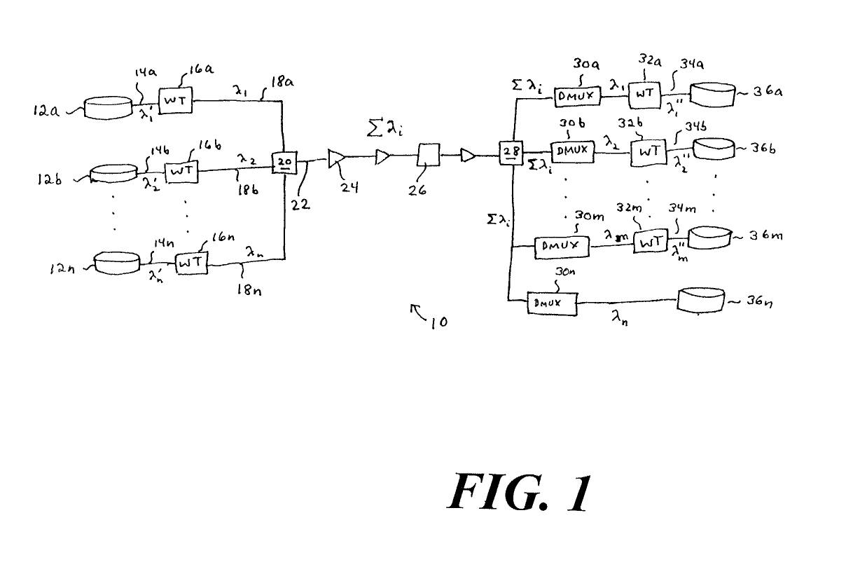

FIG. 1 shows a communication system 10 connected to several internet-traffic sources 12a-n, each of which generates an source beam 14a-n at source wavelengths λ₁′, λ₂′ . . . λₙ′. The source wavelength is tuned to a value specific to the type of router. Where the internet-traffic source is a typical router, source wavelengths are generally either 1310 nanometers or 1550 nanometers. The source beam 14a-n of each internet-traffic source 12a-n is modulated in accordance with the data that the corresponding router 12a-n is to send over the communication system 10.

The source beams 14a-n of the internet-traffic sources 12a-n are provided as inputs to corresponding wavelength translators 16a-n. Each wavelength translator 16a-n generates a transmission beam 18a-n at a transmission wavelength λ₁, λ₂ . . . λₙ. These transmission wavelengths are typically in the C band between 1530 and 1565 nanometers or in the L band between 1565 and 1620 nanometers. The transmission beams 18a-n from each of the wavelength translators 18a-n are provided to a first optical coupler 20.

The first optical coupler 20 combines the transmission beams 18a-n from all internet-traffic sources 12a-n and places those beams on an optical fiber 22. A communication system 10 according to the invention can incorporate any type of optical fiber 22. However, because of the anticipated growth in internet traffic, it is preferable that optical fibers capable of transmission at OC-192 or higher be used in implementing the communication system 10.

The wave propagating on the optical fiber 22 is thus the superposition of the transmission beams 18a-n associated with each of the internet-traffic sources 12a-n. In this way, the wavelength translators 16a-n and the first optical coupler 20 cooperate to function as a wavelength division multiplexer.

In a typical ultra-long haul fiber-optic network, distances are sufficiently long so that the amplitude of the propagating wave decreases significantly. To remedy this, amplifiers 24 are placed on the optical fiber 22 at intervals of approximately 60 miles.

In an optical fiber 22, different frequency components of a signal propagate at different speeds. This results in dispersion: the broadening and distortion of pulses as they propagate along the optical fiber 22. To correct for the effect of dispersion, it is useful to provide regenerators 26 at intervals along the optical fiber 22. Such regenerators 26 can be optical-electronic-optical devices. Alternatively, such regenerators 26 can be all-optical devices, such as selected lengths of negative-dispersion fiber. However, the use of all-optical regenerators will enhance the overall efficiency of the communication system 10.

The optical fiber 22 terminates in a second optical coupler 28 that distributes the superposition of beams to each of a plurality of demultiplexers 30a-n. Each demultiplexer 30a-n selects one of the transmission wavelengths λ₁, λ₂ . . . λₙ and provides the beam having that wavelength to an internet-traffic destination 36a-n.

In some cases, an internet-traffic destination 36a-m may not be capable of receiving the selected transmission wavelength directly. In these cases, the corresponding demultiplexers 30a-m provides the beams having the selected transmission wavelengths to wavelength translators 32a-m associated with those demultiplexers 30a-m. The wavelength translators 32a-m generate corresponding destination beams 34a-m at destination wavelengths λ₁″, λ₂″ . . . λₘ″. The destination beams 34a-m are then provided to internet-traffic destinations 36a-m connected to the corresponding wavelength translators 32a-m.

In other cases, an internet-traffic destination 36n is capable of receiving the selected transmission wavelength directly. In these cases, the corresponding demultiplexer 30n provides the beam having that wavelength directly to the internet-traffic destination 36n.

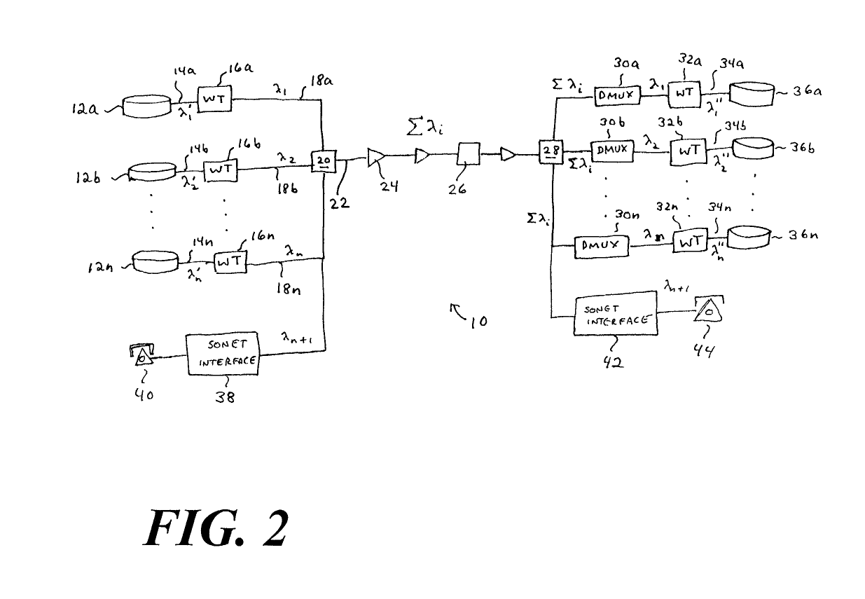

In another embodiment, shown in FIG. 2, the optical fiber 22 carries both internet traffic and SONET traffic. This embodiment is identical to that discussed above in connection with FIG. 1 except for the addition of a source SONET interface 38 connected between a SONET-traffic source 40 and the first optical coupler 20 and a destination SONET interface 42 connected between a SONET-traffic destination 44 and the second optical coupler 28. Because SONET traffic is assigned to its own wavelength on the optical fiber 22, the internet traffic on the remaining wavelengths is unaffected by the presence of SONET traffic. The communication system 10 thus enables the sharing of the same optical fiber 22 between SONET traffic and internet traffic. SONET traffic can exist between nodes having limited processing capability, and therefore requiring the benefits of SONET. Internet traffic can exist between nodes having significant processing capability, for which the benefits of SONET are, to a great extent, redundant.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Having described the invention, and a preferred embodiment thereof, what we claim as new, and secured by letters patent is:

1. A communication system comprising:
an optical transmission network having an input end and an output end;
a wavelength division multiplexer coupled to said input end of said optical transmission network, said wavelength division multiplexer being configured to receive data packets directly from each internet-traffic source in a plurality of internet-traffic sources and to modulate, in response to said data packets, a corresponding plurality of optical beams, each of said optical beams having a selected wavelength; and
a wavelength division demultiplexer coupled to said output end of said optical transmission network, said wavelength division demultiplexer being configured to select a particular optical beam from said plurality of optical beams and to retrieve data packets therefrom.

2. The communication system of claim 1 wherein said wavelength division multiplexer comprises:
a plurality of wavelength translators, each of said wavelength translators being directly connected to an internet-traffic source from said first plurality of internet-traffic sources and configured to modulate an optical beam in response to data packets received from said internet-traffic source, said optical beam having a selected wavelength;
an optical coupler in communication with each of said wavelength translators and coupled to said input end of said optical transmission network.

3. The communication system of claim 1, wherein said communication system further comprises:
a plurality of wavelength translators, each of said wavelength translators being directly connected to an internet-traffic destination selected from a plurality of internet-traffic destinations and being configured to provide data packets received from said demultiplexer to said internet-traffic destination.

4. The communication system of claim 1, further comprising a first SONET interface coupled to said input end of said optical transmission network, said first SONET interface being configured to receive data from a SONET-traffic source packaged in a SONET frame for transmission on said optical transmission network on a selected wavelength dedicated to SONET traffic.

5. The communication system of claim 4, further comprising a second SONET interface coupled to said output end of said optical transmission network, said second SONET interface being configured to retrieve said SONET frame from said optical transmission network and to provide said data contained therein to a SONET traffic destination.

6. The communication system of claim 1, wherein said optical transmission network comprises an optical fiber configured for data transmission at rates of OC-192 or greater.

7. A method comprising:
providing an optical transmission network having an input end and an output end;
coupling a wavelength division multiplexer to said input end of said optical transmission network,
configuring said wavelength division multiplexer to receive data packets directly from each internet-traffic source in a plurality of internet-traffic sources and to modulate, in response to said data packets, a corresponding plurality of optical beams, each of said optical beams having a selected wavelength;
coupling a wavelength division demultiplexer to said output end of said optical transmission network, said wavelength division demultiplexer; and
configuring said wavelength division demultiplexer to select a particular optical beam from said plurality of optical beams and to retrieve data packets therefrom.

8. The method of claim 7 wherein said coupling said wavelength division multiplexer comprises:
connecting each of a plurality of wavelength translators directly connected to an internet-traffic source from said first plurality of internet-traffic sources;
configuring each of said wavelength translators to modulate an optical beam in response to data packets received from said internet-traffic source, said optical beam having a selected wavelength;
coupling an optical coupler in communication with each of said wavelength translators to said input end of said optical transmission network.

9. The method of claim 7, wherein said method further comprises:
coupling a plurality of wavelength translators to said internet-traffic destination, each of said wavelength translators being directly connected to an internet-traffic destination selected from a plurality of internet-traffic destinations and being configured to provide data packets received from said demultiplexer.

10. The method of claim 7, further comprising coupling a first SONET interface to said input end of said optical transmission network, said first SONET interface being configured to receive data from a SONET-traffic source packaged in a SONET frame for transmission on said optical transmission network on a selected wavelength dedicated to SONET traffic.

11. The method of claim 10, further comprising coupling a second SONET interface to said output end of said optical transmission network, said second SONET interface being configured to retrieve said SONET frame from said optical transmission network and to provide said data contained therein to a SONET traffic destination.

12. The method of claim 7, wherein providing said optical transmission network comprises an providing an optical fiber configured for data transmission at rates of OC-192 or greater.
